(19) United States
(12) Patent Application Publication
(10) Pub. No.: US 2010/0011719 A1
(43) Pub. Date: Jan. 21, 2010

(54) Riding saddle with gullet plate, and gullet plate

(76) Inventor: Hans Spirig, St. Gallen (CH)

Correspondence Address: Marshall Dennehey Warner Coleman Goggin, 200 lake Drive East Suite 300, Cherry Hill, NJ, 08002, US

(21) Appl. No.: 11/991,045

(22) PCT Filed: Oct. 19, 2006
(86) PCT No.: PCT/US06/40891

§ 371 Date: Feb. 26, 2008

(30) Foreign Application Priority Data
Nov. 11, 2005 (EP) 05110658.1

(51) Int. Cl. B68C 1/00

(52) U.S. Cl. 54/44.5; 54/44.1

(57) ABSTRACT

The invention concerns a riding saddle (200) with a gullet plate (101; 101′) as well as a gullet plate (101, 101′).

A gullet plate (101, 101′), which is designed and arranged in a riding saddle (200) so that the foremost part (103) of the gullet plate (101; 101′) is situated above the lowermost part (104) and, when the riding saddle (200) is mounted, the gullet plate arms (102, 102′) enclosing the back of the horse (11) on its downward facing ends (105) each define a pressure surface (112) with a longitudinal extent that runs roughly parallel to the dorsal vertebrae (3) of the animal, contributing to more uniform weight distribution on the forehand and hind quarters and simultaneously giving the rider considerable latitude in order to convey commands with his body language.

This is also achieved by a gullet plate (101; 101′) that has a support surface (111) to support the riding saddle (200) relative to the withers musculature of the horse on both sides and a pressure surface (112) on both sides for weight distribution onto the costal arch (18) of the horse, in which both the support surfaces (11) and the pressure surfaces (112) leave free space (127) for the shoulder blades (14) and the withers musculature of the horse.

The invention concerns a riding saddle with a gullet plate as well as a gullet plate.

Riding saddles are divided into two main categories. Sport saddles, which include jumping and dressage saddles, and traditional saddles, which include Western saddles.

Whereas traditional saddles with cushioning on two longitudinal members have large under-cushioning and are suitable for long rides, sport saddles have only short members under the seat surface and increase the pressure of the rider's weight. They permit very finely tuned commands. These saddles are generally not recommended for long rides.

It is especially important for a dressage saddle that the rider have good contact with the horse in order to be able to give commands to the horse with his body language. A massive saddle tree, which is equipped with shape-stable support elements in the seat area, disconnects the rider from the horse. A dressage saddle is therefore equipped with a lighter saddle tree. The saddle blade runs almost vertically downward. It enables the rider to sit with almost stretched legs tightly on the horse and permits precise, point-like cross and leg effects.

The gullet plate assumes a significant contribution for the stabilization of the riding saddle, especially the dressage saddle for the mentioned reasons and therefore for weight distribution of the support load. The gullet plate gives the saddle stability in the front area, that is, on the side facing the head of the horse. The usual gullet plate is a roughly U-shaped arc. It has support surfaces with which it supports the riding saddle relative to the neck muscles and keeps the area of the spinal processes of the cervical vertebrae free from the saddle support so that the saddle is not positioned too close to the neck of the horse and does not slide too far forward.

The terms “front”, “rear”, “top” and “bottom” always refer to a standing horse, in which “front” refers to the side facing the head of the horse, “rear” the side facing the tail of the horse, “top” and “bottom” the two vertical directions.

It is essential for any riding saddle, be it a sport or traditional saddle, that it fit the horse. A poorly sitting saddle creates pressure sites and sprains and can even lead to serious disease of the horse. Especially in the sports area, the performance of the horse can be impaired.

Horses that are now used in performance sports have a more pronounced hind quarter relative to older horse breeds. This places new demands on the riding saddles to be used because these horses are particularly vulnerable with respect to overloading of the forehand.

Because of these properties of the breed and the use of methods that readily dispense with time-demanding warm-up phases, sporting horses have a tendency toward sprains of the trapezius muscles, the neck muscles and the anterior back muscles.

It is therefore necessary that riding saddles that load the front musculature as little as possible should be available.

Riding saddles with replaceable gullet plates are known from prior art, for example, DE 37 02 011 C1. The ability to be replaced is prescribed in order to better adapt the saddle to the anatomy of the horse, particularly allowing for a size change due to the growth of the horse. The targeted relief of the front musculature, however, is not achieved.

Air cushion systems for cushioning saddles are also known from prior art, which ensure uniform distribution of contact pressure throughout the saddle. Potential pressure points can be avoided but targeted pressure distribution is not possible.

A gullet plate with curvature on both sides is known from U.S. Pat. No. 5,517,808, which leaves room for the shoulder blades of the horse. The front-most point of the gullet plate is situated roughly at the level at which the stirrup mounts are applied. In addition, the ends of the gullet plate are surrounded with shock absorbing material.

The shape of the gullet plate permits free mobility of the front legs and reduces the shock effect between the gullet plate and shoulder blades, especially when a forehand is extended forward. The weight of the rider, however, lies largely in the front area of the horse, thereby putting a load on the front musculature.

The task of the invention is to devise a saddle that overcomes the drawbacks of the known ones and contributes to more uniform weight distribution on the forehand and hind quarters, while giving the rider considerable latitude to transmit commands with his body language. The musculature in the area of the withers and shoulders is to be relieved.

The task is solved by a riding saddle with a gullet plate designed and arranged in the saddle so that the foremost part of the gullet plate is situated above the lowermost part and with the mounted saddle the gullet plate arms enclosing the back of the horse on their downward facing ends each define a pressure surface with a longitudinal extent that extends roughly parallel to the dorsal vertebrae of the animal.

The dorsal vertebrae run between the cervical vertebrae and the lumbar vertebrae of the horse and therefore point roughly from the front to the rear. Actually the dorsal vertebra column is slightly curved so that the vertebral canal viewed from the head initially runs somewhat upward over a few vertebrae and then back downward. The ribs extend away from the dorsal vertebrae so that the costal arch follows the trend of the dorsal vertebrae.

The pressure surface according to the invention, whose longitudinal extent runs rearward roughly parallel to the dorsal vertebrae, causes the weight of the rider to also be supported on the costal arch of the horse. The load is therefore at least partially transmitted through the gullet plate over the costal arch to the pelvis and to the rear musculature. The foremost point of the gullet plate has to lie above the lowest point so that the shoulder blade can move free of collision. Otherwise there is a hazard that the shoulder blade of the horse will slip beneath the end of the gullet plate during a corresponding movement of the horse and the pressure surface of the end of the gullet plate will be raised from the costal arch. The shoulder blade and the back musculature can be irritated by such collision.

If the gullet plate does not touch the shoulder blade of the horse at any leg position, the forehand of the horse remains free and the weight of the rider is transmitted to the forehand and more to the costal arch.

The task is also solved by a riding saddle with a gullet plate in which the gullet plate is designed and arranged in the saddle so that with a saddle mounted, the gullet plate has a pressure surface on both sides for weight distribution on the costal arch of the horse in which the gullet plate leaves room for the shoulder blades and withers musculature of the horse.

It is therefore guaranteed that with the riding saddle mounted the shoulder blades can move free of collision.

The gullet plate also preferably has a support surface on both sides to support the saddle relative to the withers musculature of the horse, in which both the support surfaces and the pressure surfaces leave room for the shoulder blades of the horse.

The support surfaces ensure the actual task of the gullet plate, namely keeping the spinal processes free while the pressure surfaces direct part of the rider's weight over the costal arch to the rear musculature. The pressure surfaces alone can also keep the spinal processes free.

In an advantageous variant the gullet plate arms and/or supports surfaces and the pressure surfaces have a longitudinal extent in which the longitudinal axes of the pressure surface and the support surface, or the gullet plate arm, encloses an angle less than or equal to 90°.

The pressure surface can be created, for example, by widening of the downward pointing gullet plate arms.

In a preferred variant, the pressure surfaces are formed by downward pointing gullet plate ends.

The gullet plate ends can then be designed in roughly L-shaped continuations in which one arm of the L runs in an extension of a gullet plate arm and the other arm of the L runs rearward and therefore roughly parallel to the dorsal vertebrae. The second arm forms the pressure surface, over which part of the weight is guided to the costal arch.

In a preferred variant the riding saddle is equipped with a gullet plate whose ends, fastened to the gullet plate arms, are releasable. Replacement of gullet plate ends of different design is therefore possible. Replacement can be carried out if the physiognomy of the horse in the region of the shoulder and withers changes, for example, by muscle buildup or degradation or growth. Because of this, a gullet plate end can be chosen or prepared, whose pressure surface is optimally positioned on the costal arch and leaves free space for the shoulder blades and the withers musculature and therefore exerts no substantial pressure on them.

The gullet plate ends can be fixed for example by means of a plug, screw or clamp connection to the gullet plate arms.

As an alternative, the gullet plate arms ends are designed in one piece, for example by welding of the gullet plate ends to the gullet plate arms. A tempered steel alloy is preferably prescribed as material.

Between the gullet plate and back of the horse there is generally a pad that distributes the weight of the rider on the back of the horse and prevents pressure sites on the horse's back.

Depending on the design of the pad or pad material, the pressure surface of the end of the gullet plate may push the filling material across the pressure surface. The cushioning effect is reduced in the region of the pressure surface and buildup of pad material at another location can lead to redistribution of the pressure, for example in the direction of the withers muscle. The saddle therefore preferably has a pad with a division in an extension of the end of the gullet plate. A chamber separation between the pad parts prevents the pad material from being pushed across the longitudinal axis of the pressure surface of the end of the gullet plate.

The chamber separation can be in the form of a stitching.

In a particularly favorable variant, the pad above and beneath the pad division is not the same, but the pad filling is tighter and/or more shape-stable beneath the pad division than above the pad division. The resulting different hardness of the pad reinforces the intended pressure or weight distribution on the costal arch in which the support surface of the end of the gullet plate is not cushioned and seemingly enlarged.

The saddle pads consist of various wool felts and are filled with sheep's wool, but foam-shaped pads made of latex or plastic foam are also considered.

In an advantageous variant, the riding saddle has two positioning shoes for the introduction of the ends of the gullet plate on the inside facing the horse. The positioning shoes accommodate the ends of the gullet plate like pockets and ensure defined positioning of the pad and gullet plate. At the same time they permit loosening of the pad and therefore replacement of the gullet plate or its ends.

The positioning shoe can be opened and closed with Velcro closures. Another fastening between the pad and ends of the gullet plate (for example, a screw connection) is not necessary. If the ends of the gullet plate are to be replaced, only the Velcro closure need be loosened.

Advantageously, the fastenings for the stirrups are attached to the gullet plate at the level of the foremost point of the gullet plate.

Mounts for the stirrups, longitudinal bars and/or additional components of the saddle tree are preferably riveted or screwed to the gullet plate.

In one variant, the gullet plate is riveted into the saddle tree. Generally the saddle tree is stabilized by two longitudinal steel bars. These are also riveted to the gullet plate and lead to the saddle shield. There the longitudinal bars are soldered to the rear iron, which is fastened beneath the shield. A screw connection that facilitates replacement of the gullet plate can be provided as an alternative.

The straps stabilize the saddle on the horse. With adjustable belts there is a possibility of compensating for the natural asymmetry of the horse.

In one variant according to the invention, on the outside surface of the riding saddle at least one opening is provided which permits replacement of the gullet plate and/or its ends. The opening can extend over the entire length of the gullet plate and be with a Velcro closure or zipper. After opening, the gullet plate can be conveniently grasped and fully or partially replaced. As an alternative, one or more slit-like openings can also be provided through which the gullet plate or parts of it can be pulled out from the saddle pad.

Generally a riding saddle is designed in layers, for example pad elements, saddle tree parts and saddle leather layers. The layers, joined to each other, are also releasable for replacement and/or refitting of the gullet plate. After at least partial loosening of the layers, the saddle can be swung out to provide access to a gullet plate and its fastenings.

The positioning shoe, by which the gullet plate end can be accommodated in the mounted state, is situated between an upper plate and the welded plate. After the plate is tilted back, there is access exists to the positioning shoe and the end of the gullet plate.

The task is also solved by a riding saddle that is adaptable to the shape of the horse by refitting the gullet plate, especially changing the gullet plate ends.

Weight distribution on the costal arch can only effectively occur if the shape of the gullet plate is adapted to the shape, i.e., the size and form of the musculature of the horse. If the horse, for example, builds up muscles during a training cycle, an unduly narrow gullet plate can lead to adverse effects and pressure sites. If, on the other hand, a horse has lost muscle during a training pause, the pressure surfaces of a gullet plate will no longer be sufficient to guarantee weight absorption.

Since the significant changes of an animal occur in the lower region of the gullet plate, it is fully sufficient to refit the gullet plate in the region of its ends, by replacing them. For this purpose either the entire gullet plate can be removed from the riding saddle and modified or the central section of the gullet plate left in a saddle and only the gullet plate ends removed and replaced. In the latter case the central section of the gullet plate is fixed in the riding saddle.

Changing of the gullet plate ends can be carried out, for example, by the replacement of the entire gullet plate or by the replacement of its ends.

It can also be prescribed to lock the gullet plate ends in adjustable positions. The gullet plate ends would then not have to be replaced only adjusted.

The task is also solved by a gullet plate for a riding saddle especially with the aforementioned features, designed and mountable in a riding saddle so that the foremost part of the gullet plate is situated above the lowermost part and the gullet plate arms enclosing the back of the horse each define a pressure surface on their downward and rearward pointing ends that extends roughly parallel to the dorsal vertebrae of the animal when mounted on the back of the horse.

The task is also solved via a gullet plate for a riding saddle, especially with the features described above, designed and applicable in a riding saddle so that when the saddle is mounted, the gullet plate has a pressure surface on both sides for weight distribution on the costal arch of the horse, and leaves freedom for movement of the shoulder blades of the horse.

The gullet plate preferably has a support surface on both sides to support the saddle relative to the withers musculature of the horse, in which both the support surfaces and the pressure surfaces leave room for the shoulder blades of the horse.

In a preferred variant the gullet plate has arms on both sides on whose ends an essentially L-shaped gullet plate end is situated, pointing rearward with respect to the horse.

In an advantageous embodiment of the invention, the arms of the essentially L-shaped gullet plate ends each enclose an internal angle less than or equal to 90°.

The gullet plate ends are preferably fastened in a releasable manner to the gullet plate arms.

A gullet plate with the mentioned features can be incorporated once in a new saddle. However, it can also be integrated in a riding saddle in replacement of an ordinary gullet plate or be intended from the outset for a replacement when, for example, a saddle is produced for a young or untrained horse.

The invention is also solved by a gullet plate having replaceable gullet plate ends.

The weight distribution occurs in the region of the gullet plate ends, especially if a corresponding pressure surface is present there. Adaptation of the gullet plate to the horse in the area of the gullet plate ends is therefore of great importance. Replaceable gullet plate ends permit rapid adjustment and spontaneous reaction to possible changes in the horse. By this simple expedient a mass-produced riding saddle can continue to fit for a long time.

Since the demands of the adjustment are limited, the costs connected with it are also not high.

The invention is further explained below in practical examples-with reference to the drawings. In the drawings:

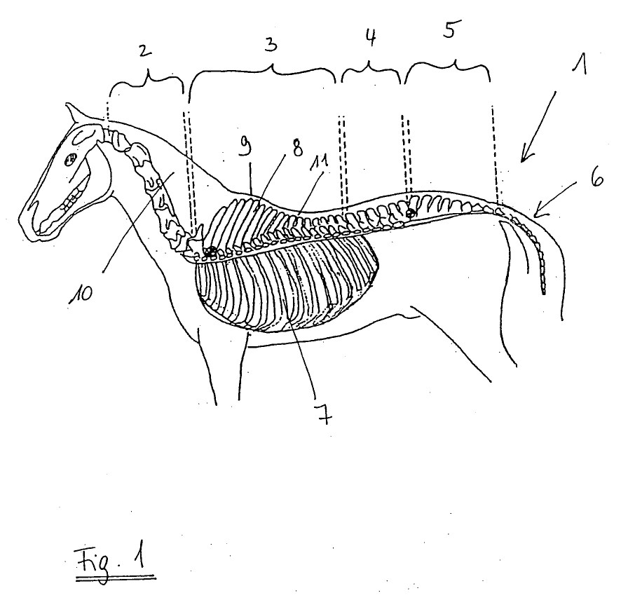

FIG. 1 shows a schematic view of the vertebrae of a horse in a side view;

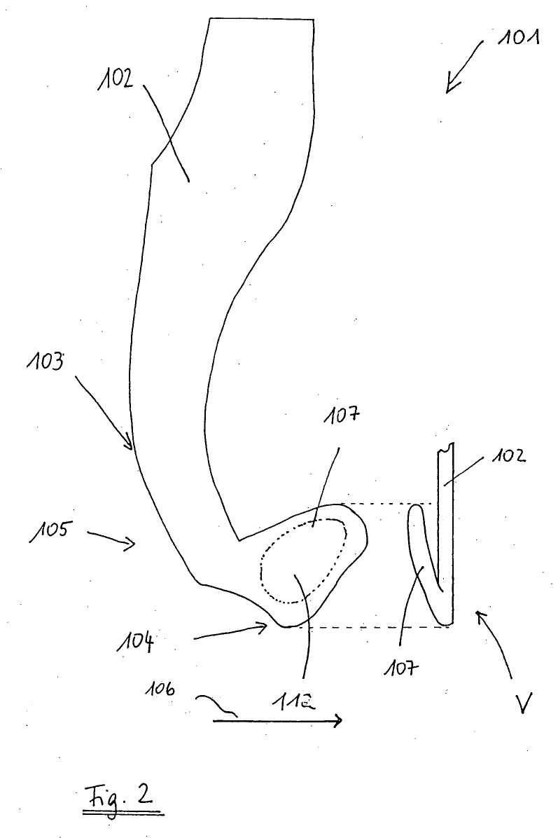

FIG. 2 shows a schematic view of a first example of a gullet plate in a side view;

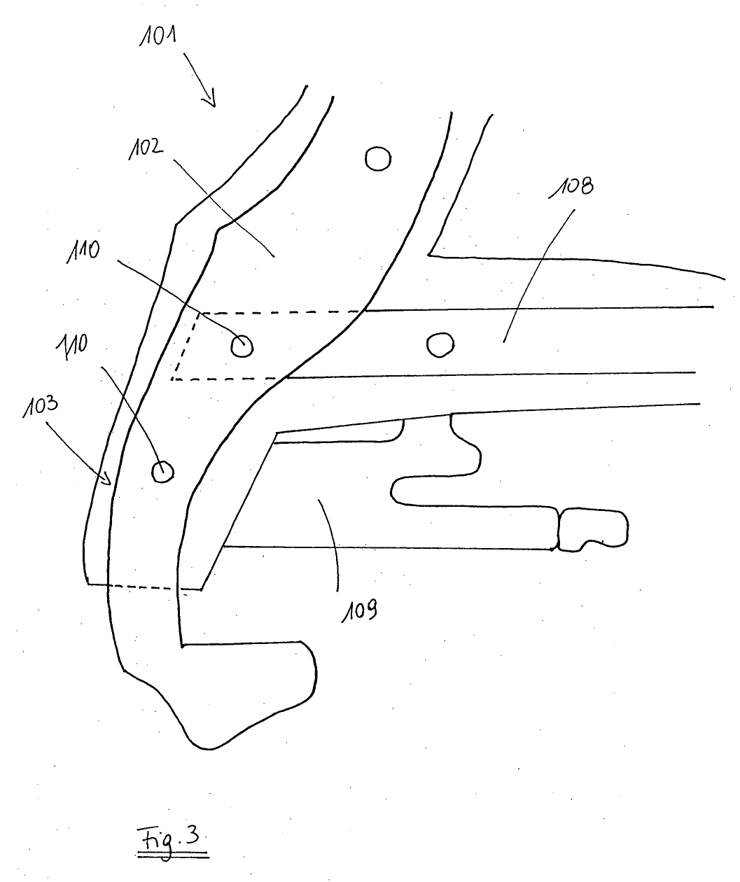

FIG. 3 shows a schematic view of another example of a gullet plate in a side view;

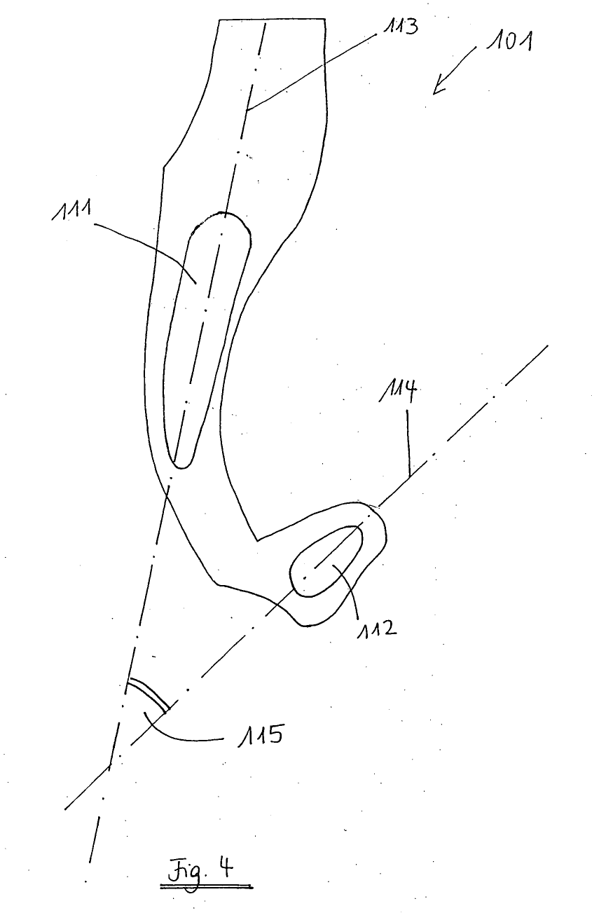

FIG. 4 shows another schematic view of the first example of a gullet plate in a side view;

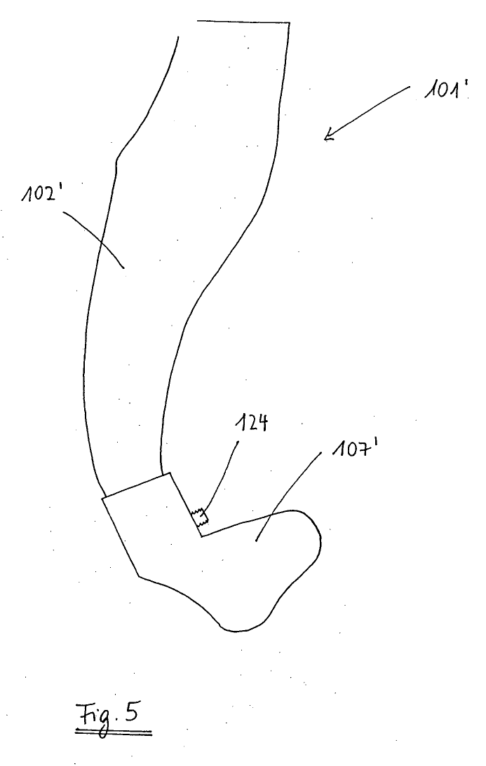

FIG. 5 shows a schematic view of another example of a gullet plate in a side view;

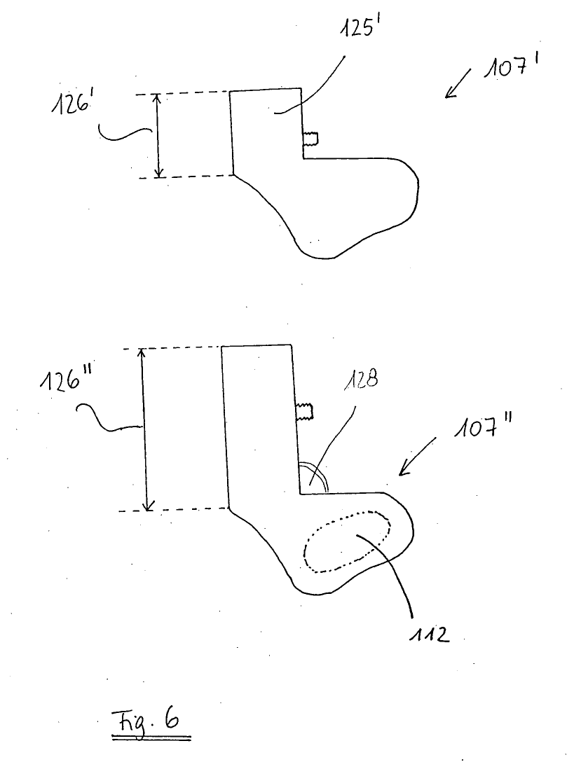

FIG. 6 shows a schematic view of two examples of gullet plate ends with different shaft lengths;

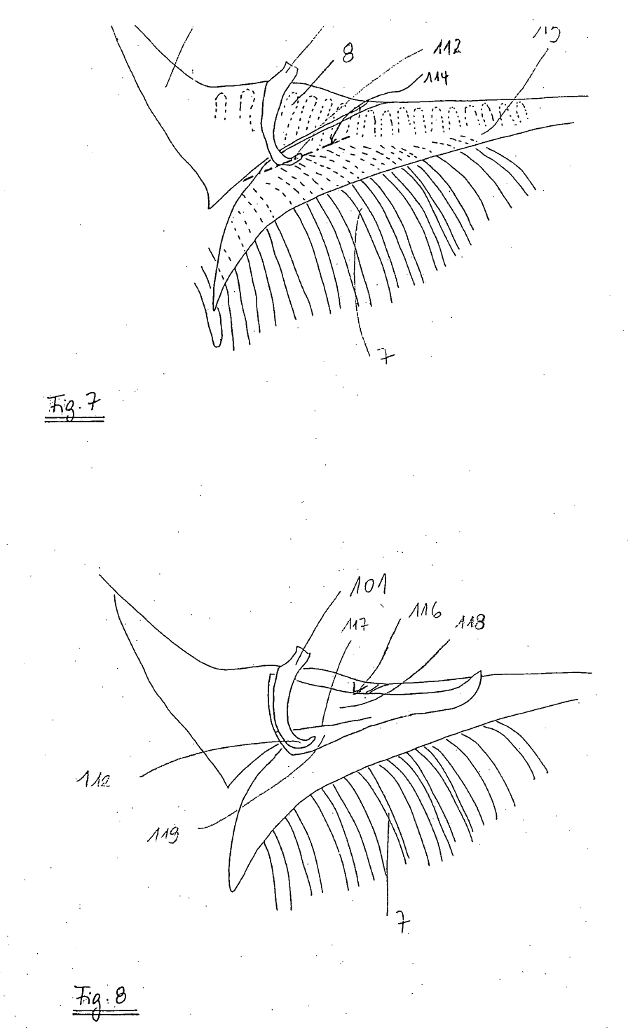

FIG. 7 shows a schematic view of an example of a gullet plate in a side view with reference to the back of the horse;

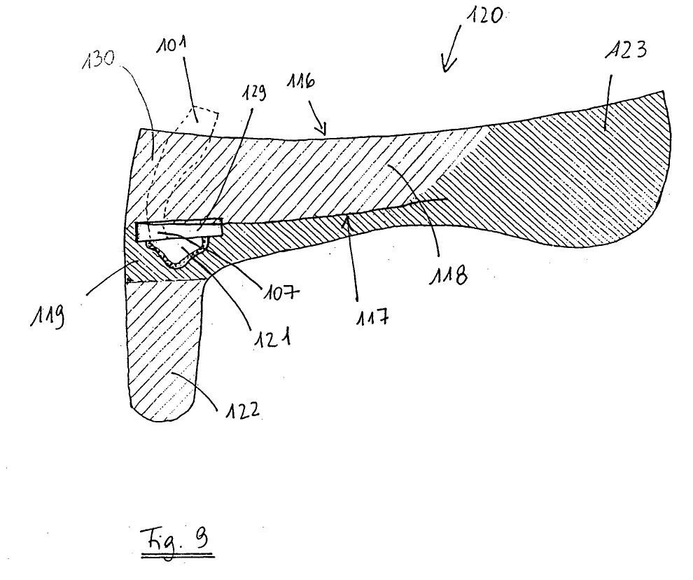

FIG. 8 shows a schematic view of an example of gullet plate cushioning in a side view;

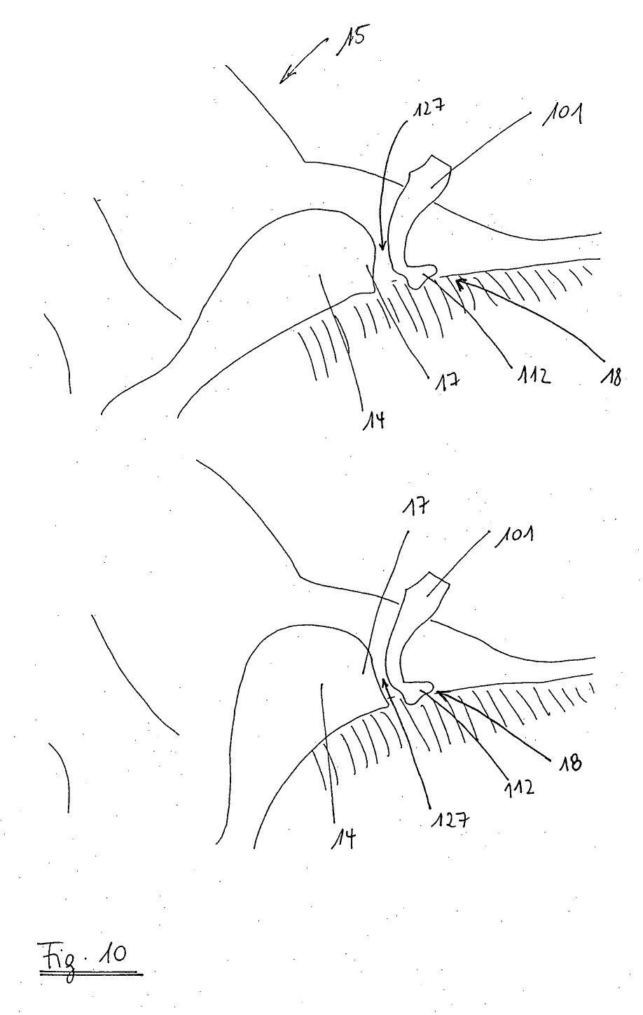

FIG. 9 shows a schematic view of an example of a design of a saddle pad in a side view;

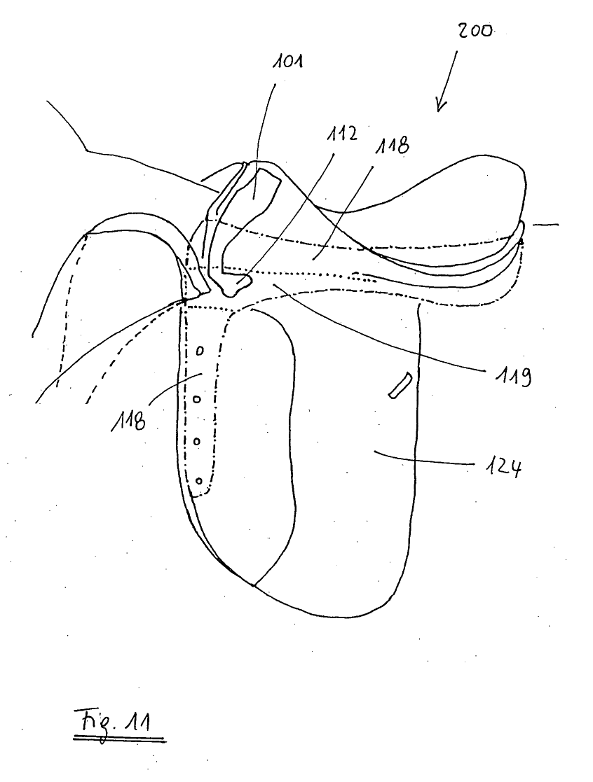

FIG. 10 shows a schematic view of an example of a gullet plate in a side view with reference to different positions of the shoulder blade of a horse;

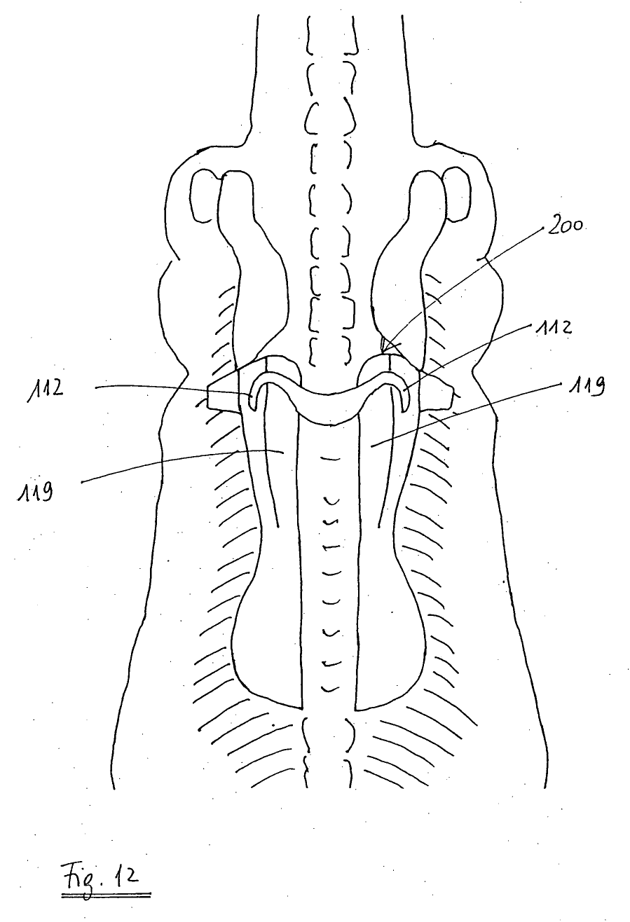

FIG. 11 shows a schematic view of an example of a rising saddle in a perspective view;

FIG. 12 shows a schematic view of an example of a design of a riding saddle in a view from above.

FIG. 1 shows a schematic view of a horse vertebral column 1 in a side view. The vertebral column 1 is divided into cervical vertebrae 2, dorsal vertebrae 3, lumbar vertebrae 4, iliac bone 5 and tail 6.

The ribs 7 are attached laterally to the dorsal vertebrae 3, the spinal processes 8 of the spine extend upward.

A saddle not shown in the drawing typically lies above the dorsal vertebrae 3, behind the withers 9, the elevated transition between neck 10 and back 11. However, it must not lie on the spinal processes 8. The saddle should be separated from the vertebral column 1 and the withers 8 by up to three finger-widths.

FIG. 2 shows a schematic view of an example of a gullet plate 101 in a side view.

The gullet plate 101 has gullet plate arms 102 whose foremost part 103 is situated above the lowermost part 104. On the downward facing end 105 of gullet plate arm 102 a downward facing 106 gullet plate end 107 is situated. It forms a pressure surface 112 which transfers or distributes the weight of the rider to the ribs 7.

The schematic indication of the front view V shows that the rearward facing gullet plate ends 107 do not lie in the same plane as the gullet plate arm 102, but is directed outward relative to the horse in order to be able to follow the contour of the trend of the costal arch 18 shown in FIG. 10.

FIG. 3 shows a schematic view of an example of a gullet plate 101 in a side view. A longitudinal bar 108 is applied to the gullet plate arm 102 and at roughly the level of the foremost part 103 a fastening 109 is applied for a stirrup not shown in the figure. The connection occurs by means of rivets 110.

FIG. 4 shows a schematic view of an example of a gullet plate 101 in a side view. The gullet plate 101 has a support surface 111 for side stabilization of the saddle, not shown in the figure, and to support the saddle relative to the withers musculature of the horse, as well as pressure surface 112 to distribute the weight of the rider on the costal arch of the horse (also not shown).

Longitudinal axis 113 of the support surface 111 and longitudinal axis 114 of the pressure surface 112 enclose an angle 115 that is less than 90°. This enables the pressure surface to be directed rearward to and follow the costal arch of the horse.

FIG. 5 shows another schematic view of an example of gullet plate 101 in a side view. The gullet plate end 107′ can be pushed onto the gullet plate arm 102′. Locking occurs by screw 124, which is situated on the gullet plate end 107′. The screw 124 can be screwed by means of an inbus wrench against the gullet plate arm 102′.

As an alternative, the gullet plate arm can have a receiving volume for the shaft of the gullet plate end and the gullet plate end can be inserted into the gullet plate arm. The fastening screw in this case can be provided on the gullet plate arm.

FIG. 6 shows another schematic view of two examples of gullet plate ends 107′, 107″ with different shaft lengths 126′, 126″. The length of shaft 125′, in which the gullet plate can be introduced, varies, for example between a short shaft 126′ of 3 cm and a shaft length 126″ of 6 cm. Replacement of the gullet plate end 107′ with a short shaft 125′ by gullet plate ends 107″ with longer shaft 125″ enlarges the gullet plate overall and permits the gullet plate to be adapted to a growing horse.

Variants include gullet plate ends with pressure surfaces of different lengths.

The gullet plate 107′, 107″ is roughly L-shaped and has an internal angle 128 of 90°.

FIG. 7 shows a schematic view of an example of a gullet plate 101 in a side view with reference to the horse musculature. The gullet plate 101 is positioned above the triangular trapezius muscle 12 and keeps the saddle (not shown) away from the spinal processes 8 indicated in the figure. The gullet plate 101 has the pressure surface 112 whose longitudinal extent 114 runs roughly parallel to the dorsal vertebrae (not shown). The pressure surface 112 transmits the weight pressure of the rider to the back muscles 13 and ribs 7 so that part of the weight can be supported by the short back muscles.

The effect is intensified by a corresponding padding. FIG. 8 shows a schematic view of an example of a gullet plate 101 and pad 116 in a side view.

The pad 116 has a pad division 117, which separates the two lengthwise chambers or areas 118, 119, a softer padded area 118 and a more densely padded area 119 from each other.

The hard padded area 119 acts as a support pad part in an extension of the pressure surface 112. The pad division 117 prevents the pad material from being pushed upward by the counter-pressure of the ribs 7 into the softly padded area 118.

FIG. 9 shows a schematic view of an example of a design of a saddle pad 120 in a side view.

The gullet plate 101 is connected to pad 116 via a positioning shoe 121 for the gullet plate end 107. The gullet plate end 107 can be introduced to the positioning shoe 121 and held by it in pocket-like fashion. The positioning shoe 121 can additionally be opened and closed with a Velcro closure 129.

The positioning shoe 121 is applied to the inside of the pad 116, which has pad division 117, which separates a softly padded area 118 filled, for example, with soft wool, from a densely padded and therefore supporting area 119. The latter is filled, for example, with mixed wool of medium hardness. In the withers part 130 and in the area of the pommels 122, a soft padding is present, whereas in the area of the saddle shield 123 a denser and therefore supporting filling is provided.

We claim:

1. A riding saddle with a gullet plate designed and arranged in the riding saddle so that the foremost part of the gullet plate is situated above the lowermost part and when the riding saddle is mounted the gullet plate arms enclosing the back of the horse define on their downward facing ends a pressure surface with a longitudinal extent that runs roughly parallel to the dorsal vertebrae of the animal.

2. A riding saddle with a gullet plate designed and arranged in the riding saddle so that when the riding saddle is mounted the gullet plate has on both sides a pressure surface for weight distribution onto the costal arch of the horse in which the gullet plate leaves room for movement of the shoulder blades of the horse.

3. The riding saddle as in any of the preceding claims in which the pressure surfaces are formed by gullet plate ends pointing rearward with respect to the horse.

4. The riding saddle according to claim 3 in which the gullet plate is designed so that when the riding saddle is mounted support of the riding saddle relative to the withers musculature of the horse exists on both sides with the support surfaces and the pressure surfaces leaving space for the shoulder blades of the horse.

5. The riding saddle as in any of the preceding claims in which the pressure surface and the support surface each have a longitudinal extent and the corresponding longitudinal axes enclose an angle less than or equal to 90 degrees.

6. The riding saddle according to claim 5 in which the riding saddle has a pad that has rearward facing pad divisions in an extension of the gullet plate ends.

7. The riding saddle as in any of the preceding claims in which the riding saddle has a pad that has rearward facing pad divisions in an extension of the gullet plate ends.

8. The riding saddle according to claim 7 in which the pad has a filling material that is denser and or more shape-stable beneath the pad division than above the pad division.

9. The riding saddle as in any of the preceding claims in which the riding saddle has two positioning shoes for introduction of the gullet plate ends on the inside facing of the horse.

10. The riding saddle as in any of the preceding claims in which the fastenings for the stirrups on the gullet plate are attached at roughly the height of the foremost part of the gullet plate.

11. The riding saddle as in claim 10 in which the fastenings for the stirrups, longitudinal bars and additional components of the saddle tree are riveted or screwed to the gullet plate.

12. The riding saddle as in any of the preceding claims in which the riding saddle is adaptable to the shape of the horse by refitting the gullet plate by changing the gullet plate ends.

13. The riding saddle as in any of the preceding claims in which the riding saddle has a pad having pad divisions that extend roughly parallel to the dorsal vertebrae of the animal in which the pad has a filing material that is denser and more shape-stable beneath the pad division.

14. A saddle horn for a riding saddle according to one of the preceding claims designed and mountable in a riding saddle so that the foremose part of the gullet plate is situated above the lowermost part and the gullet plate arms enclosing the back of the horse define their downward facing ends a pressure surface with a longitudinal extent that extends roughly parallel to the dorsal vertebrae of the animal in the mounted state on the back of the horse.

15. A gullet plate for a riding saddle according to one of the proceeding claims designed and mountable in a riding saddle so that when the riding saddle is mounted the gullet plate has a pressure surface on both sides for weight distribution onto the costal arch of the horse and the gullet plate leaves space for the movement of the shoulder blades of the horse.

16. A gullet plate according to claim 14 or 15 in which the gullet plate when the riding saddle is mounted has a support surface on both sides for support of the saddle relative to the withers musculature of the horse in which both the support surfaces and the pressure surfaces leave free space for the shoulder blades of the horse.

17. A gullet plate according to one of the claims 14, 15 or 16 in which the gullet plate has arms on both sides whose essentially L-shaped gullet plate ends are situated pointing rearward with respect to the horse.

18. A gullet plate according to claim 17 in which the essentially L-shaped gullet plate ends each enclose an internal angel less than or equal to 90 degrees.

19. A gullet plate according to claim 17 or 18 in which the gullet plate ends are fastened in a releasable manner to the gullet plate arms.

20. A gullet plate as in any one of the preceeding claims in which the gullet plate has replaceable ends.
